(19) United States
(12) Patent Application Publication
(10) Pub. No.: US 2007/0133989 A1
(43) Pub. Date: Jun. 14, 2007

(54) GPON system and method for bandwidth allocation in GPON system

(76) Inventors: Yu-Gun Kim, Yongin-si (KR); Byeong-Hoon Kim, Suwon-si (KR); Tae-Sung Park, Yongin-si (KR); Jeong-Won Park, Yongin-si (KR); Jai-Young Park, Seoul (KR); Jong-Kook Kim, Seoul (KR); Dong-Keun Kim, Gunpo-si (KR); Su-Hyung Kim, Seoul (KR); Jae-Young Lee, Seoul (KR); Jae-Hyun Kim, Seoul (KR); Hoon-Jae Yeon, Seoul (KR)

Correspondence Address: Robert E. Bushnell, Suite 300, 1522 K Street, N.W., Washington, DC, 20005-1202, US

(21) Appl. No.: 11/592,274

(22) Filed: Nov. 3, 2006

(30) Foreign Application Priority Data
Dec. 8, 2005 (KR) 10-2005-0119693

(51) Int. Cl. H04J 14/00

(52) U.S. Cl. 398/69

(57) ABSTRACT

In a gigabit-capable passive optical network (GPON) system and in a method for bandwidth allocation in a passive optical network (PON) system, a minimum bandwidth is allocated to optical network units (ONUs) for minimal transmission assurance dependent on a traffic characteristic of each ONU, and when there is a traffic-container (T-CONT) class of an ONU not allocated bandwidth after minimum bandwidth allocation to all ONUs, an extra bandwidth remaining after minimum bandwidth allocation is dynamically allocated to each T-CONT class according to a weight of the T-CONT class. Thus, efficient bandwidth allocation, considering fairness between ONUs and priority of each T-CONT, is realized.

### CLAIM OF PRIORITY

This application makes reference to, incorporates the same herein, and claims all benefits accruing under 35 U.S.C. §119 from an application for GPON SYSTEM AND METHOD FOR BANDWIDTH ALLOCATION IN GPON SYSTEM earlier filed in the Korean Intellectual Property Office on the 8^{th} of December 2005 and there duly assigned Serial No. 10-2005-0119693.

### BACKGROUND OF THE INVENTION

1. Technical Field

The present invention relates to a passive optical network (PON) system, and more particularly, to a method for bandwidth allocation for upstream in a gigabit-capable passive optical network (GPON) system.

2. Related Art

Subscriber networks have been rapidly changing in recent years. With the development of Internet service and xDSL technology, and the propagation of cable television (CATV) and wireless communication, a great number of people have come to use subscriber networks. In addition, high speed, stability, and quality of service need to be guaranteed. Subscriber networks have characteristics of a short arrival distance or around 20 km and distributed user traffic. In particular, in South Korea, a geographically small country, the arrival distance of a subscriber network is as short as about 10 km. A subscriber network is an arrangement of relatively simple systems, each including a telephone office node, a subscriber access point (AP) node, and a single link connecting the two nodes. Such a network is called a loop. A loop cannot be substituted by another loop and individually corresponds to an independent line. Accordingly, routing, traffic, and network management in a subscriber network are different from those in a typical infrastructure network. As a result, the subscriber network may refer to an independent network requiring different techniques than those applied in a typical network.

Copper cable used in most of the current subscriber networks has a transmission loss limit. Accordingly, subscriber accommodation area is limited. Such a copper cable has a limit with respect to transmission loss and high frequency transmission, and the transmission characteristic of the copper cable is insufficient to provide broad-band service. A recent subscriber network, such as VDSL, can provide communication at an upstream/downstream rate of 6.4 Mbps/52 Mbps, or bi-directional communication at 13 Mbps for a distance up to 1.5 km, which may be insufficient to meet growing demand for broad-band multimedia in the near future. In view of this situation, the subscriber network may be built by using Fiber To The Home (FTTH) to satisfy future demand for broad-band multimedia. The subscriber network using FTTH has the advantages of an excellent optical cable transmission characteristic, no electrical failure, and the ability to meet future demand for broad-band using various multiplexing techniques. This subscriber network may be very competitive in view of the recent price drop of transceivers, passive optical devices, and the like.

A passive optical network (PON) has a subscriber network structure with a distributed topology having a tree structure formed by connecting several optical network units (ONUs) with one optical cable termination (OLT) using a passive splitter. PON technology can be used to build a highly reliable, inexpensive access network by shortening the total length of an optical cable and using only passive optical devices, and can deliver signals among several subscribers to a high-speed infrastructure network by combining and multiplexing the signals. Thus, a,PON system has been suggested as suitable for implementing Fiber To The Home (FTTH) and Fiber To The Curb (FTTC).

PON includes four elements such as OLT, an optical distribution network (ODN), ONU, and an element management system (EMS). OLT functions as an interface between PON and a backbone network, such as an edge switch. EMS operates, manages, and maintains the entire PON system, and monitors the performance of the PON system. OLT may generally include an EMS function. ODN is composed of only passive optical elements, such as optical fiber, a splitter, and a connector, and has a bus or tree structure and a physical range of 20 km. ONU is a section which is directly connected with a subscriber network, and the position of ONU varies with its application, such as Fiber To The Building (FTTB), FTTC, Fiber To The Office (FTTO), and FTTH.

Examples of PONs include ATM PON (APON), Gigabit-capable PON (GPON), Ethernet PON (EPON), and Wavelength Division Multiplexing PON (WDMPON). Among them, EPON is attracting increasing attention as an attractive solution in a broad-band, high-speed subscriber network because it realizes low Ethernet equipment cost and low optics-based cost by using a popular Ethernet technique. In EPON, it is very important to control upstream traffic because different ONUs need to share an upstream channel in order to send data. In addition, with ongoing study of EPON, bandwidth use efficiency and quality of service (QoS) have been of growing concern.

GPON began at FSAN OAN WG in April 2001 with efforts to establish a standard capable of accommodating an Ethernet frame in conventional ATM-PON, as 95% of Internet traffic is delivered through the Ethernet frame and Ethernet data capacity rapidly increases from the 10 or 100M class to a Gpbs class. GPON has been achieved by major businesses such as NTT, SBC, BT, and KT, and is currently standardized. For example, G984.X series recommendations were completed in June 2004. A fundamental rule of GPON is to accommodate ATM, Ethernet, and TDM services, and to maximally accommodate a basic design concept of a previous ATM-PON. GPON is aimed at a full service network (FSN), and has the characteristic of providing voice, HDTV class video, E1/T1 TDM service, and 10/100/1000 base Ethernet service in an upstream/downstream 622 Mbps/2.4 Gbps band.

In GPON, traffic on a downstream channel is broadcast from one OLT to a number of ONUs, while traffic on an upstream channel is transmitted from a number of ONUs to an upper OLT. Accordingly, a proper channel or time slot needs to be allocated to the upstream channel. Basically, GPON employs a dynamic bandwidth allocation (DBA) algorithm suggested by ATM-PON. However, GPON does not assure quality of various services and performance defined by Traffic-Container (T-CONT).

A standard for the GPON system was no longer announced after the ITU-T recommendation G.984.4 was announced in June 2004. Because DBA in the GPON system is not yet actively studied, a DBA algorithm in GPON accommodates a conventional ATM-PON BPON system.

In a suggested bandwidth allocation system in ATM-PON, each ONU has several QoS sub-queues, monitors a queue length of a buffer which accommodates cells generated from a non-real-time connection, and delivers the queue length to an OLT through a mini-slot. The OLT calculates a bandwidth allocated to each ONU by referring to bandwidth information defined in each ONU and the number of non-real-time cells delivered through the mini-slot, and allocates to the ONU a data grant corresponding to the calculated bandwidth. In response to receiving the grant, the ONU selects one QoS sub-queue through a weighted round robin (WRR) scheduler, and transmits one cell in the sub-queue to OLT on the slot.

The method for dynamic bandwidth allocation in ATM-PON supports quality of various services by using five requested items of bandwidth information defined in each ONU, as well as buffer state information of the ONU obtained through the mini-slot. The five requested items of bandwidth information are a fixed bandwidth, an assured bandwidth, an effective bandwidth, a maximum bandwidth, and a dynamic bandwidth.

Among the five requested items of bandwidth information, the fixed bandwidth is periodically allocated to the ONU at all times, and is defined as the sum of peak cell rates (PCRs) of all real-time connections which are established in the ONU. The assured bandwidth is an average bandwidth which is assured for non-real-time connections of the ONU, and is defined as the sum of sustainable cell rates (SCR) or minimum cell rates (MCRs) for the established non-real-time connections. This value is updated only when a new non-real-time connection is established or released, and is referred to when a dynamic bandwidth to be allocated to non-real-time traffic is calculated.

Furthermore, the maximum bandwidth is a maximum bandwidth which can be allocated to the ONU, and is defined as the sum of peak cell rates of all connections established in the ONU. The effective bandwidth is an average bandwidth which should be ensured for real-time connections of the ONU, and is defined as the sum of SCRs of the established real-time connections. In the case of constant bit rate (CBR) service, the SCR may be equal to the PCR.

Finally, the dynamic bandwidth is defined as a bandwidth allocated to the ONU according to a DBA algorithm in a bandwidth remaining after the fixed bandwidth is allocated based on the number of non-real-time cells in a standby state in the ONU and the assured bandwidth information set in each ONU.

In the conventional algorithm described above, since the fixed bandwidth and the assured bandwidth are first distributed to each ONU, if a specific ONU is allotted less fixed, assured, and dynamic bandwidths relative to the other ONUs, the specific ONU may be not allocated the dynamic bandwidth even though it uses relatively less bandwidth than the other ONUs.

### SUMMARY OF THE INVENTION

It is an object of the present invention to provide a gigabit-capable passive optical network (GPON) system, and a method for bandwidth allocation in the GPON system, which are capable of providing fairness between optical network units (ONUs) not provided by a conventional method, and performing dynamic bandwidth allocation using a weight of each traffic-container (T-CONT).

One aspect of the present invention provides a method for bandwidth allocation in a passive optical network (PON) system, in which an optical cable termination (OLT) allocates an upstream bandwidth to at least one ONU, the method comprising the steps of: allocating, to each ONU, a minimum bandwidth for minimal transmission assurance dependent on a traffic characteristic of the ONU; and, when there is a T-CONT class of an ONU not allocated bandwidth after minimum bandwidth allocation to all ONUs, dynamically allocating an extra bandwidth remaining after minimum bandwidth allocation to each T-CONT class according to a weight of the T-CONT class.

The dynamically allocated bandwidth may be calculated by the following equation:

$${Additional\_BW}_{j} = \frac{{k}_{j}}{{\sum }_{j = 1}^{5} {k}_{j} A ( j )} \times remaining BW ,$$

where Additional_BWⱼ denotes a dynamic bandwidth allocated to a T-CONT class j, kⱼ denotes a weight of the T-CONTj class j, A(j) denotes the number of ONUs having a T-CONT class j requiring bandwidth allocation, and remaining BW denotes the extra bandwidth remaining after minimum bandwidth allocation.

The weight of each T-CONT class may be set according to importance, dependent on the traffic characteristic of each T-CONT class.

The step of allocating a minimum bandwidth may comprise allocating relatively less bandwidth to an ONU in which traffic having a burst characteristic is frequently generated, and allocating relatively more bandwidth to an ONU in which traffic having a real-time characteristic is frequently generated.

The method may further comprise the step of transmitting, to each ONU, information about a total bandwidth allocated to the ONU, the total bandwidth information including the minimum bandwidth allocated to each ONU and the dynamic bandwidth allocated to each T-CONT class.

The total bandwidth allocated to each ONU may be calculated by the following equation:

$${Allocated\_BW}_{i} = Min\_BW + {\sum }_{k = 1}^{5} Additiona \overline{l} {BW}_{k}$$

where Allocated_BWᵢ denotes a total bandwidth allocated to the i-th ONU, k denotes a T-CONT class of the i-th ONU requiring additional allocation, wherein only when there is the T-CONT class k of the i-th ONU requiring additional allocation, Additional_BWₖ is applied to the equation, and when the T-CONT class k of ONU does not require the additional allocation, the Additional_BWₖ is ignored.

The step of allocating a minimum bandwidth may comprise allocating the bandwidth requested by an ONU to the ONU when the requested bandwidth does not exceed the minimum bandwidth set in the ONU.

Another aspect of the present invention provides a PON system comprising: an OLT for allocating, to each ONU, a minimum bandwidth for minimal transmission assurance dependent on a traffic characteristic of the ONU, and when there is a T-CONT class of an ONU not allocated bandwidth after minimum bandwidth allocation to all ONUs, for dynamically allocating an extra bandwidth remaining after minimum bandwidth allocation to each T-CONT class according to a weight of the T-CONT class; and at least one ONU for transmitting upstream traffic to the OLT through the bandwidth allocated by the OLT.

Yet another aspect of the present invention provides an OLT for allocating an upstream bandwidth to at least one ONU, the OLT allocating, to each ONU, a minimum bandwidth for minimal transmission assurance dependent on a traffic characteristic of the ONU, and when there is a T-CONT class of an ONU not allocated bandwidth after minimum bandwidth allocation to all ONUs, dynamically allocating an extra bandwidth remaining after minimum bandwidth allocation to each T-CONT class according to a weight of the T-CONT class.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a flowchart of a dynamic bandwidth allocation procedure in a passive optical network (PON) system;

FIG. 2 is a diagram of the structure of a PON system according to the present invention;

FIG. 3 is a diagram of the configuration of a queue of each traffic-container (T-CONT) class of an optical network unit (ONU) according to the present invention; and

FIG. 4 is a flowchart of a method for bandwidth allocation in a GPON system according to an exemplary embodiment of the present invention.

### DETAILED DESCRIPTION OF THE INVENTION

Hereinafter, exemplary embodiments of the present invention will be described in detail with reference to the accompanying drawings. In the following description, a detailed description of known functions and configurations incorporated herein has been omitted for conciseness.

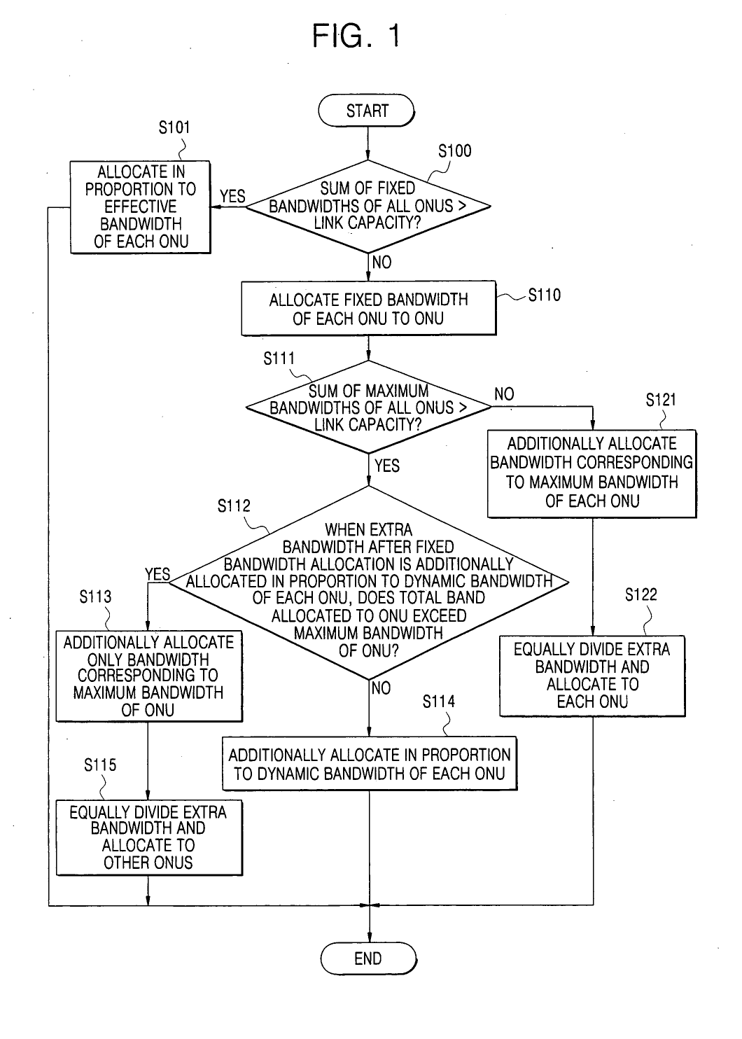

FIG. 1 is a flowchart of a dynamic bandwidth allocation procedure in a passive optical network (PON) system.

A basic dynamic bandwidth allocation (DBA) procedure using the above five requested items of band information will be described with reference to FIG. 1.

First, it is determined whether the sum of fixed bandwidths of all optical network units (ONUs) exceeds available link capacity (S100). If the sum of fixed bandwidths of all ONUs exceeds the available link capacity (YES in S100), bandwidth is allocated to each ONU in proportion to the effective bandwidth of the ONU (S101). In this case, the bandwidth allocated in proportion to the effective bandwidth becomes the fixed bandwidth of the ONU.

If the sum of the fixed bandwidths of all ONUs does not exceed the available link capacity (NO in S100), the fixed bandwidth of each ONU is allocated to the ONU (S110). For an extra bandwidth remaining after the fixed bandwidth allocation to each ONU, it is determined whether the sum of the maximum bandwidths of all ONUs exceeds the link capacity (S111). If the sum of the maximum bandwidths of all ONUs does not exceed the link capacity (NO in S111), a bandwidth corresponding to the maximum bandwidth of each ONU is additionally allocated (S121). Extra bandwidth remaining after additional allocation of the bandwidth corresponding to the maximum bandwidth of each ONU is equally divided and allocated to each ONU (S122).

On the other hand, if the sum of the maximum bandwidths of all ONUs exceeds the link capacity (YES in S111) and the extra bandwidth after the fixed bandwidth allocation is additionally allocated in proportion to the dynamic bandwidth of each ONU, it is determined whether a total bandwidth to be allocated to the ONU (the fixed bandwidth plus the dynamic bandwidth) exceeds the maximum bandwidth of the ONU (S112). If the total bandwidth to be allocated to the ONU exceeds the maximum bandwidth of the ONU, only a bandwidth corresponding to the maximum bandwidth of the ONU is additionally allocated (S113). The remaining extra bandwidth is equally divided and allocated to other ONUs (S115). If the total bandwidth allocated to the ONU does not exceed the maximum bandwidth of the ONU (NO in S112), the bandwidth is additionally allocated in proportion to the dynamic bandwidth of each ONU (S114).

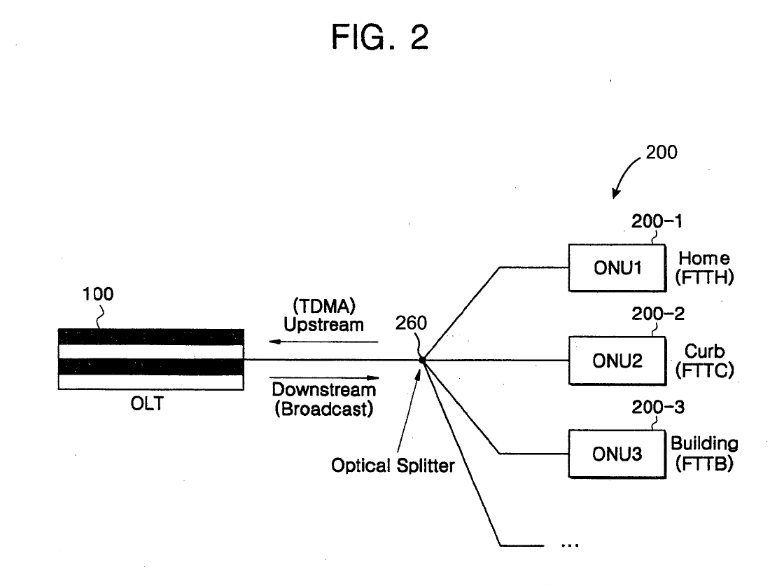

FIG. 2 is a diagram of the structure of a PON system according to the present invention.

The Ethernet passive optical network (EPON) system includes an optical cable termination (OLT) 100, optical network units (ONUs) 200, an optical splitter 260, and the like, as shown in FIG. 2. As previously described, downstream traffic from the OLT 100 to the ONUs 200 is transmitted using a broadcast system, and upstream traffic from the ONUs. 200 to the OLT 100 is transmitted using a TDMA system.

As shown in FIG. 2, in the PON system, downstream transmission flow from an external network to a subscriber is achieved from the OLT 100 to all ONUs 200-1, 200-2 and 200-3 in a point-to-multi-point manner due to a physical tree connection characteristic of the PON system. On the other hand, since upstream transmission flow from the subscriber to the external network is achieved in a point-to-point manner between each ONU 200-1, 200-2 and 200-3 and the OLT 100, the respective distributed ONUs 200-1, 200-2 and 200-3 need to transmit data to the OLT 100 without conflicting with each other. The gigabit-capable passive optical network (GPON) uses a time division multiple access (TDMA) system as a bandwidth allocation system for upstream band access from a number of ONUs to one OLT.

In FIG. 2, the OLT 100 requests a report for traffic-containers (T-CONTs) of each ONU 200 using physical control block downstream (PCBD) of downstream traffic at specific periods. Upon receipt of the request, each ONU 200 reports a queue state of each T-CONT. In response to receiving the report on the current queue state of T-CONTs of each ONU 200, the OLT 100 allocates a bandwidth to each T-CONT.

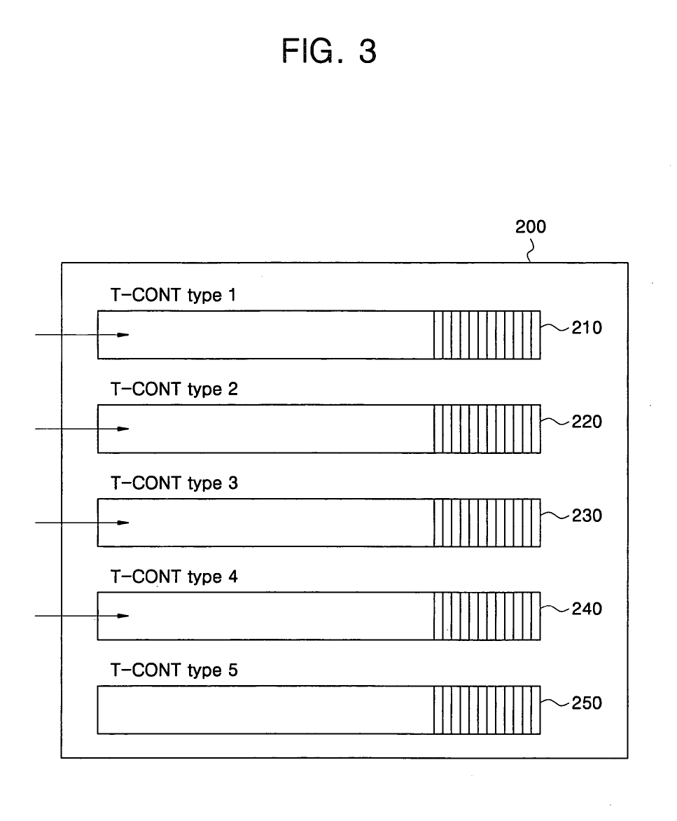

FIG. 3 is a diagram of the configuration of a queue of each traffic-container (T-CONT) class of an optical network unit (ONU) according to the present invention.

Referring to FIG. 3, an ONU 200 according to the present invention has queues 210, 220, 230, 240 and 250 of a traffic container (T-CONT) type, such as T-CONT1, T-CONT2, T-CONT3, T-CONT4 and T-CONT5 according to the ITU-T G.983.4 specification. T-CONT1 is defined for a fixed bandwidth, T-CONT2 for an assured bandwidth, T-CONT3 for assured and non-assured bandwidths, and T-CONT4 for a best effort (BE) bandwidth. T-CONT5 is provided for operations administration and maintenance (OAM) and queue-length report.

The priority according to the bandwidth is high in order of fixed bandwidth, assured bandwidth, non-assured bandwidth, and BE bandwidth. As the priority of each T-CONT is determined in such a manner, the priority is set in order of T-CONT1, T-CONT2, T-CONT3, and T-CONT4.

The ONU 200 transmits upstream traffic of each T-CONT class using the bandwidth allocated by the OLT 100.

In this manner, the method for bandwidth allocation based on the PON structure shown in FIGS. 2 and 3 according to the present invention includes the process of allocating a bandwidth to obtain fairness between the ONUs 200, and the process of elastically allocating an extra bandwidth which can effectively accommodate burst traffic.

To obtain fairness between the ONUs 200, the OLT 100 allocates a minimum bandwidth Min_BW to each ONU in the tree structure. The minimum bandwidth assures minimal transmission for each ONU. Thereafter, the OLT 100 allocates a requested bandwidth to an ONU when the sum of bandwidths of T-CONTs requested by the ONU does not exceed a bandwidth allocated to each ONU, and allocates a minimum bandwidth to the ONU when the sum of the requested bandwidths exceeds the specified minimum allocation bandwidth. The minimum bandwidths may differ in respective ONUs, and be preset by a system manager.

A portion of the allocated bandwidth is allocated to each T-CONT according to an ONU scheduling method. The minimum bandwidth is a parameter specified by the network manager, and enables the network manager to elastically build the network. After such a process is performed on each ONU, the sum of the minimum bandwidths allocated to the respective ONUs may be smaller than a whole link capacity. Accordingly, an extra bandwidth may arise and there may be T-CONTs that are not allocated bandwidth.

To effectively accommodate burst traffic, a method is used which dynamically allocates extra bandwidth remaining after minimum bandwidth allocation to each T-CONT of each ONU not allocated bandwidth in proportion to a weight of the T-CONT.

The method for minimum bandwidth allocation and the method for dynamic bandwidth allocation according to the present invention will now be described in more detail.

In the method for minimum bandwidth allocation, the OLT 100 allocates a minimum bandwidth for obtaining minimal transmission fairness to each ONU in a tree structure. Thereafter, the OLT 100 allocates a requested bandwidth to an ONU when the sum of bandwidths of T-CONTs requested by the ONU does not exceed a bandwidth allocated to each ONU, and allocates a minimum allocation bandwidth to the ONU when the sum of the requested bandwidths exceeds the specified minimum allocation bandwidth.

In this regard, the size of the minimum bandwidth is determined by the network manager or policy as described above, and enables elastic configuration of the network. If traffic having a burst characteristic is frequently generated, burst transmission can be maximally supported by reducing the size of the minimum bandwidth. If there is a large amount of traffic having a real-time characteristic, such as video on demand (VoD) and audio on demand (AoD), and requiring that a certain minimum transfer rate be maintained, several changes in the network can be coped with by increasing the size of the minimum bandwidth. After such a process is performed on each ONU, an extra bandwidth may arise if the sum of the minimum bandwidths allocated to the respective ONUs is smaller than the whole link capacity. Of course, T-CONTs not allocated bandwidth may arise.

In the method for dynamic bandwidth allocation according to the present invention, a remaining bandwidth is allocated based on the priority of T-CONTs not allocated an extra bandwidth leftover after minimum bandwidth allocation.

The OLT 100 requests a report on whether there is extra bandwidth remaining after allocation of the minimum bandwidth or a corresponding requested bandwidth to ONUs 200, and whether there are T-CONTs not yet allocated (or insufficiently allocated) bandwidth. In response to receiving, from an ONU, information about a T-CONT not yet allocated bandwidth even though there is extra bandwidth available, the OLT 100 additionally allocates a bandwidth corresponding to a weight of the T-CONT preset by the network manager.

When it is assumed that the weights of the respective T-CONT classes in the GPON system are k1 to k5, respectively, the bandwidth allocated to each class is determined by the following Equation 1:

$${Additional\_BW}_{j} = \frac{{k}_{j}}{{\sum }_{j = 1}^{5} {k}_{j} A ( j )} \times remaining BW \qquad Equation 1$$

where Additional_BWⱼ denotes a dynamic bandwidth allocated to T-CONT class j, kⱼ denotes a weight of the T-CONT class j, A(j) denotes the number of ONUs having a T-CONT class j requiring bandwidth allocation, and remaining BW denotes an extra bandwidth remaining after minimum bandwidth allocation.

Accordingly, a total bandwidth Allocated_BWᵢ allocated to the i-th ONU can be represented by Equation 2:

$${Allocated\_BW}_{i} = Min\_BW + {\sum }_{k = 1}^{5} {Additional\_BW}_{k} , \qquad Equation 2$$

where Allocated_BWᵢ denotes a total bandwidth allocated to the i-th ONU, and k denotes a T-CONT class of the i-th ONU requiring the additional allocation. In this case, Additional_BWₖ is applied to Equation 2 only when the T-CONT class k of the i-th ONU requires additional allocation. When the ONU does not require additional allocation to the T-CONT class k, the Additional_BWₖ is ignored.

An example of the above-described method for dynamic bandwidth allocation according to the present invention will be described.

In a GPON system having three T-CONT classes, an extra bandwidth Additional BW remaining after minimum bandwidth allocation is assumed to be 10M. Furthermore, when it is assumed that weight ratios for T-CONT classes are K1=0.5, K2=0.3, and K3=0.2 and there are two ONUs having T-CONT1, two ONUs having T-CONT2, and one ONU having T-CONT3 (the respective ONUs may have overlapping T-CONT), a bandwidth additionally allocated to T-CONT1 is calculated as follows:

$${Additional\_BW}_{1} = \frac{0.5}{0.5 \times 2 + 0.3 \times 2 + 0.2 \times 1} \times 10 M = 2.77 M$$

Similarly, a bandwidth additionally allocated to T-CONT2 is calculated as follows:

$${Additional\_BW}_{2} = \frac{0.3}{0.5 \times 2 + 0.3 \times 2 + 0.2 \times 1} \times 10 M = 1.6 M$$

Furthermore, a bandwidth additionally allocated to T-CONT3 is calculated as follows:

$${Additional\_BW}_{3} = \frac{0.2}{0.5 \times 2 + 0.3 \times 2 + 0.2 \times 1} \times 10 M = 1.1 M$$

If an ONU has T-CONT1 and T-CONT2, it is allocated an additional bandwidth corresponding to 4.37M (=2.77M+1.6M).

After allocating the minimum bandwidth to each ONU and additionally allocating the bandwidth to each T-CONT of each ONU as described in Equations 1 and 2, the OLT 100 transmits a bandwidth allocation result to each ONU, so that each ONU transmits upstream traffic corresponding to the allocated bandwidth upon the next transmission.

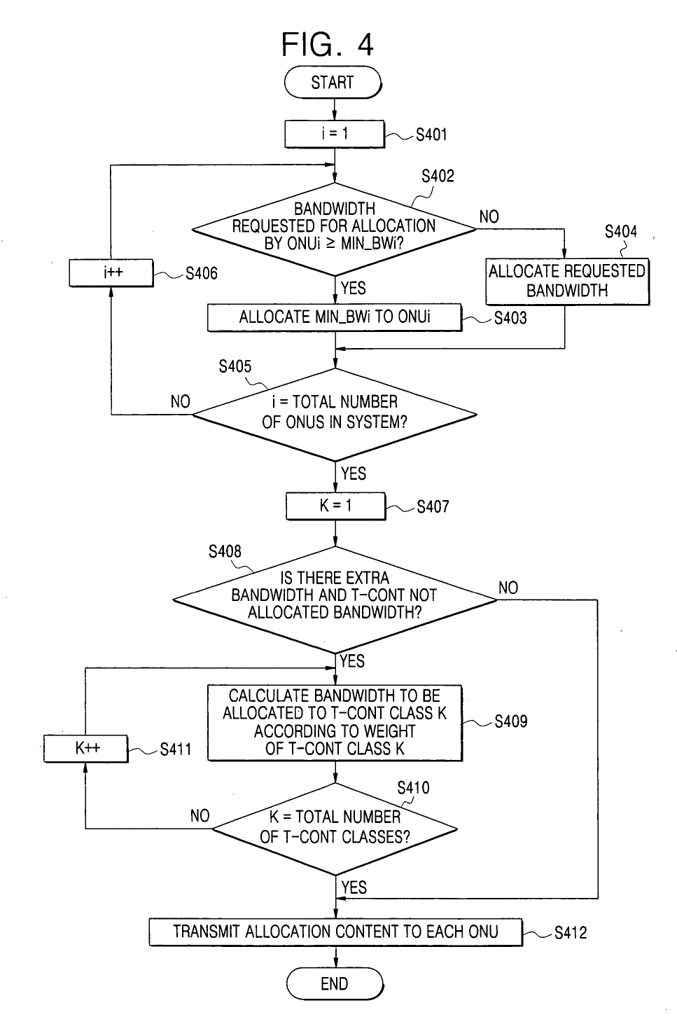

The above-described method for bandwidth allocation according to the present invention may be summarized as in FIG. 4.

FIG. 4 is a flowchart of a method for bandwidth allocation in a GPON system according to an exemplary embodiment of the present invention.

An index i indicating a particular ONU is set and initialized as 1 (S401). The OLT 100 receives a request for bandwidth allocation from an ONUi and determines whether the requested bandwidth exceeds a minimum bandwidth Min_BWᵢ of the ONUi (S402). If the requested bandwidth exceeds the minimum bandwidth (YES in S402), it allocates the minimum bandwidth Min_BWᵢ to the ONUi (S403). Otherwise (NO in S402), it allocates the bandwidth requested by the ONUi (S404).

The above-described minimum bandwidth allocation procedure should be performed on all ONUs. Thus, the procedure (S402 to S404) needs to be repeated until the value of the index i reaches the total number of ONUs in the system. To this end, it is determined whether i equals the total number of ONUs in the system (S405). If i is not equal to the total number of ONUs (NO in S405), i is incremented by one (S406) and steps S402 to S404 are repeated.

If i is equal to the total number of ONUs (YES in S405), the minimum bandwidth allocation procedure ends and the dynamic bandwidth allocation process begins.

The dynamic bandwidth allocation process begins with setting the value of the variable k indicating the T-CONT class to 1 (S407). After allocating the minimum bandwidth, the OLT 100 requests each ONU to report whether it has T-CONTs not allocated bandwidth. Upon receipt of the report from each ONU, the OLT 100 determines whether there is extra bandwidth and T-CONTs not allocated bandwidth after minimum bandwidth allocation (S408), and if the latter condition is met (YES in S408), OLT 100 calculates a bandwidth to be allocated to the T-CONT class k according to the weight of the T-CONT class k (S409). Equation 1 is used to calculate the bandwidth. Since the dynamic bandwidth allocation process should be performed on all T-CONT classes, it is determined whether the k value is equal to the total number of T-CONT classes (S410). If not, the k value is incremented by one (S411) and step S409 is repeated.

If there is no extra bandwidth or no T-CONT class not allocated bandwidth (S408), or if dynamic bandwidth allocation to all the T-CONT classes is completed (YES in S410), allocation content (namely, information about the minimum bandwidth (or requested bandwidth) allocated to each ONU and the dynamic bandwidth) is transmitted to each ONU (S412).

According to the present invention, efficient bandwidth allocation considering ONU fairness and T-CONT priority in the GPON system can be realized by allocating the minimum bandwidth to each ONU, and allocating an additional bandwidth in proportional to the priority of each T-CONT of the ONUs.

While the present invention has been described with reference to exemplary embodiments thereof, it will be understood by those skilled in the art that various changes in form and detail may be made therein without departing from the scope of the present invention as defined by the following claims.

What is claimed is:

1. A method for bandwidth allocation in a passive optical network (PON) system, in which an optical cable termination (OLT) allocates an upstream bandwidth to at least one optical network unit (ONU), the method comprising the steps of:
allocating, to each ONU, a minimum bandwidth for minimal transmission assurance dependent on a traffic characteristic of said each ONU; and
when there is a traffic-container (T-CONT) class of an ONU not allocated bandwidth after minimum bandwidth allocation to all ONUs, dynamically allocating an extra bandwidth remaining after minimum bandwidth allocation to each T-CONT class according to a weight of the T-CONT class.

2. The method of claim 1, wherein the dynamically allocated bandwidth is calculated by the following equation:
$${Additional\_BW}_{j} = \frac{{k}_{j}}{{\sum }_{j = 1}^{5} {k}_{j} A ( j )} \times remaining BW ,$$
where Additional_BWⱼ denotes a dynamic bandwidth allocated to T-CONT class j, kⱼ denotes a weight of the T-CONT class j, A(j) denotes the number of ONUs having a T-CONT class j requiring bandwidth allocation, and remaining BW denotes the extra bandwidth remaining after minimum bandwidth allocation.

3. The method of claim 1, wherein the weight of each T-CONT class is set according to importance, dependent on the traffic characteristic of said each T-CONT class.

4. The method of claim 1, wherein the step of allocating a minimum bandwidth comprises allocating relatively less bandwidth to an ONU in which traffic having a burst characteristic is frequently generated, and allocating relatively more bandwidth to an ONU in which traffic having a real-time characteristic is frequently generated.

5. The method of claim 1, further comprising the step of transmitting, to each ONU, information about a total bandwidth allocated to said each ONU, the total bandwidth information including the minimum bandwidth allocated to said each ONU and the dynamic bandwidth allocated to each T-CONT class.

6. The method of claim 5, wherein the total bandwidth allocated to said each ONU is calculated by the following equation:
$${Additional\_BW}_{i} = Min\_BW + {\sum }_{k = 1}^{5} {Additional\_BW}_{k} ,$$
where Allocated_BWᵢ denotes a total bandwidth allocated to the i-th ONU, k denotes a T-CONT class of the i-th ONU requiring additional allocation, wherein Additional_BWₖ is applied to the equation only when T-CONT class k of the i-th ONU requires additional allocation, and Additional_Bwₖ is ignored when the T-CONT class k of the i-th ONU does not require the additional allocation.

7. The method of claim 1, wherein the step of allocating a minimum bandwidth comprises allocating the bandwidth requested by an ONU to the ONU when the requested bandwidth does not exceed the minimum bandwidth set in the ONU.

8. A passive optical network (PON) system, comprising:
an optical cable termination (OLT) for allocating, to each ONU, a minimum bandwidth for minimal transmission assurance dependent on a traffic characteristic of the ONU, and when there is a traffic-container (T-CONT) class of an ONU not allocated bandwidth after minimum bandwidth allocation to all ONUs, dynamically allocating an extra bandwidth remaining after minimum bandwidth allocation to each T-CONT class according to a weight of the T-CONT class; and
at least one ONU for transmitting upstream traffic to the OLT by means of the bandwidth allocated by the OLT.

9. The system of claim 8, wherein the dynamically allocated bandwidth is calculated by the following equation:
$${Additional\_BW}_{j} = \frac{{k}_{j}}{{\sum }_{j = 1}^{5} {k}_{j} A ( j )} \times remaining BW ,$$
where Additional_BWⱼ denotes a dynamic bandwidth allocated to T-CONT class j, kⱼ denotes a weight of the T-CONT class j, A(j) denotes the number of ONUs having a T-CONT class j requiring bandwidth allocation, and remaining BW denotes the extra bandwidth remaining after minimum bandwidth allocation.

10. The system of claim 8, wherein the weight of each T-CONT class is set according to importance, dependent on the traffic characteristic of said each T-CONT class.

11. The system of claim 8, wherein allocating a minimum bandwidth at the OLT comprises allocating relatively less bandwidth to an ONU in which traffic having a burst characteristic is frequently generated, and allocating relatively more bandwidth to an ONU in which traffic having a real-time characteristic is frequently generated.

12. The system of claim 8, wherein the OLT transmits, to each ONU, information about a total bandwidth allocated to the ONU, the total bandwidth information including the minimum bandwidth allocated to each ONU and the dynamic bandwidth allocated to each T-CONT class.

13. The system of claim 12, wherein the total bandwidth allocated to each ONU is calculated by the following equation:
$${Allocated\_BW}_{i} = Min\_BW + {\sum }_{k = 1}^{5} {Additional\_BW}_{k} ,$$
where Allocated_BWᵢ denotes a total bandwidth allocated to the i-th ONU, k denotes a T-CONT class of the i-th ONU requiring additional allocation, wherein Additional_BWₖ is applied to the equation only when T-CONT class k of the i-th ONU requires additional allocation, and Additional _BWₖ is ignored when the T-CONT class k of the i-th ONU does not require the additional allocation.

14. The system of claim 8, wherein the OLT allocates the bandwidth requested by an ONU to the ONU when the requested bandwidth does not exceed the minimum bandwidth set in the ONU.

15. An optical cable termination (OLT) for allocating an upstream band to at least one optical network unit (ONU), the OLT allocating, to each ONU, a minimum bandwidth for minimal transmission assurance dependent on a traffic characteristic of the ONU, and wherein, when there is a traffic-container (T-CONT) class of an ONU not allocated bandwidth after minimum bandwidth allocation to all ONUs, the OLT dynamically allocates an extra bandwidth remaining after minimum bandwidth allocation to each T-CONT class according to a weight of the T-CONT class.

16. The OLT of claim 15, wherein the dynamically allocated bandwidth is calculated by the following equation:
$${Additional\_BW}_{j} = \frac{{k}_{j}}{{\sum }_{j = 1}^{5} {k}_{j} A ( j )} \times remaining BW ,$$
where Additional_BWⱼ denotes a dynamic bandwidth allocated to T-CONT class j, kⱼ denotes a weight of the T-CONT class j, A(j) denotes the number of ONUs having a T-CONT class j requiring bandwidth allocation, and remaining BW denotes the extra bandwidth remaining after minimum bandwidth allocation.
